(19) United States
(12) Patent Application Publication
(10) Pub. No.: US 2016/0201882 A1
(43) Pub. Date: Jul. 14, 2016

(54) ILLUMINATION DEVICE AND LAMPSHADE MODULE THEREOF

(71) Applicant: LUSTROUS TECHNOLOGY LTD., New Taipei City (TW)

(72) Inventors: DAWSON LIU, TAIPEI CITY (TW); KAO-HSU CHOU, TAIPEI CITY (TW); JUEI-KHAI LIU, KEELUNG CITY (TW)

(21) Appl. No.: 14/592,958

(22) Filed: Jan. 9, 2015

(51) Int. Cl. F21V 17/00; F21V 17/16; F21V 1/08

(52) U.S. Cl. CPC F21V 17/002; F21V 1/08; F21V 17/164; F21Y 2101/02

(57) ABSTRACT

An illumination device includes a light-emitting module and a lampshade module. The light-emitting module includes a circuit substrate and a light-emitting unit. The lampshade module includes a casing structure disposed on the circuit substrate, a carrying structure detachably disposed on the casing structure, and a replaceable lampshade structure detachably disposed on the carrying structure. The casing structure has at least two first positioning portions, the carrying structure has at least two second positioning portions, and the carrying structure is detachably positioned on the casing structure by matching the two first positioning portions and the two second positioning portions. The carrying structure has at least two first retaining portions, the replaceable lampshade structure has at least two second retaining portions, and the replaceable lampshade structure is detachably positioned on the carrying structure by matching the two first retaining portions and the two second retaining portions.

### BACKGROUND OF THE INVENTION

1. Field of the Invention

The instant disclosure relates to an illumination device and a lampshade module thereof, and more particularly to an illumination device including a lampshade module using a replaceable lampshade structure for obtaining different light patterns according to different requirements.

2. Description of Related Art

LEDs are now widely used as illuminators, indicators or displays in many kinds of electronic products or industrial applications. One of the advantages of LEDs is that they consume much less electricity, or energy, as comparing with other traditional lighting devices. This is because the LEDs are known as solid state devices that generate light through a luminescence process. Thus, the light generated by LEDs is referred to “cold light”. Besides, another advantage of LEDs is its small size. An LED is provided as a semiconductor chip. Hence, LEDs can meet the size-reducing requirement of modern electronic products, especially the delicate electronic products.

### SUMMARY OF THE INVENTION

One aspect of the instant disclosure relates to an illumination device including a lampshade module using a replaceable lampshade structure for obtaining different light patterns according to different requirements.

One of the embodiments of the instant disclosure provides an illumination device, comprising: a light-emitting module and a lampshade module. The light-emitting module includes a circuit substrate and a light-emitting unit disposed on the circuit substrate and electrically connected to the circuit substrate. The lampshade module includes a casing structure disposed on the circuit substrate, a carrying structure detachably disposed on the casing structure, and a replaceable lampshade structure detachably disposed on the carrying structure. More precisely, the casing structure has a receiving space downwardly concaved from a top side thereof, the casing structure has a surrounding carrying surface disposed in the receiving space and an opening communicated with the receiving space for exposing the light-emitting unit. More precisely, the casing structure has at least two first positioning portions disposed on the surrounding carrying surface, the carrying structure has at least two second positioning portions respectively corresponding to the at least two first positioning portions, and the carrying structure is detachably positioned on the surrounding carrying surface of the casing structure by matching the at least two first positioning portions and the at least two second positioning portions. More precisely, the carrying structure has at least two first retaining portions, the replaceable lampshade structure has at least two second retaining portions respectively corresponding to the first retaining portions, and the replaceable lampshade structure is detachably positioned on the carrying structure by matching the at least two first retaining portions and the at least two second retaining portions.

Another one of the embodiments of the instant disclosure provides a lampshade module, comprising: a casing structure, a carrying structure, and a replaceable lampshade structure. The carrying structure is detachably disposed on the casing structure. The replaceable lampshade structure is detachably disposed on the carrying structure. More precisely, the casing structure has a receiving space downwardly concaved from a top side thereof, the casing structure has a surrounding carrying surface disposed in the receiving space and an opening communicated with the receiving space for exposing a light-emitting unit. More precisely, the casing structure has at least two first positioning portions disposed on the surrounding carrying surface, the carrying structure has at least two second positioning portions respectively corresponding to the at least two first positioning portions, and the carrying structure is detachably positioned on the surrounding carrying surface of the casing structure by matching the at least two first positioning portions and the at least two second positioning portions. More precisely, the carrying structure has at least two first retaining portions, the replaceable lampshade structure has at least two second retaining portions respectively corresponding to the first retaining portions, and the replaceable lampshade structure is detachably positioned on the carrying structure by matching the at least two first retaining portions and the at least two second retaining portions.

Therefore, the light pattern of the illumination light source generated by the illumination device can be adjusted according to different requirements due to the designs of “the replaceable lampshade structure detachably disposed on the carrying structure” and “the carrying structure having at least two first retaining portions, the replaceable lampshade structure having at least two second retaining portions respectively corresponding to the first retaining portions, and the replaceable lampshade structure detachably positioned on the carrying structure by matching the at least two first retaining portions and the at least two second retaining portions”.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a partial assembled schematic view of the illumination device according to the instant disclosure;

FIG. 2 shows an exploded schematic view of the illumination device according to the instant disclosure;

FIG. 3 shows a perspective schematic view of the carrying structure according to the instant disclosure;

FIG. 4 shows an enlarged view taken on part A of FIG. 2;

FIG. 5 shows a cross-sectional schematic view showing the relationship between the first retaining portion and the second retaining portion before retaining the first retaining portion with the second retaining portion according to the instant disclosure; and

FIG. 6 shows a cross-sectional schematic view showing the relationship between the first retaining portion and the second retaining portion after retaining the first retaining portion with the second retaining portion according to the instant disclosure.

### DETAILED DESCRIPTION OF THE PREFERRED EMBODIMENTS

The embodiments of “an illumination device and a lampshade module thereof” of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

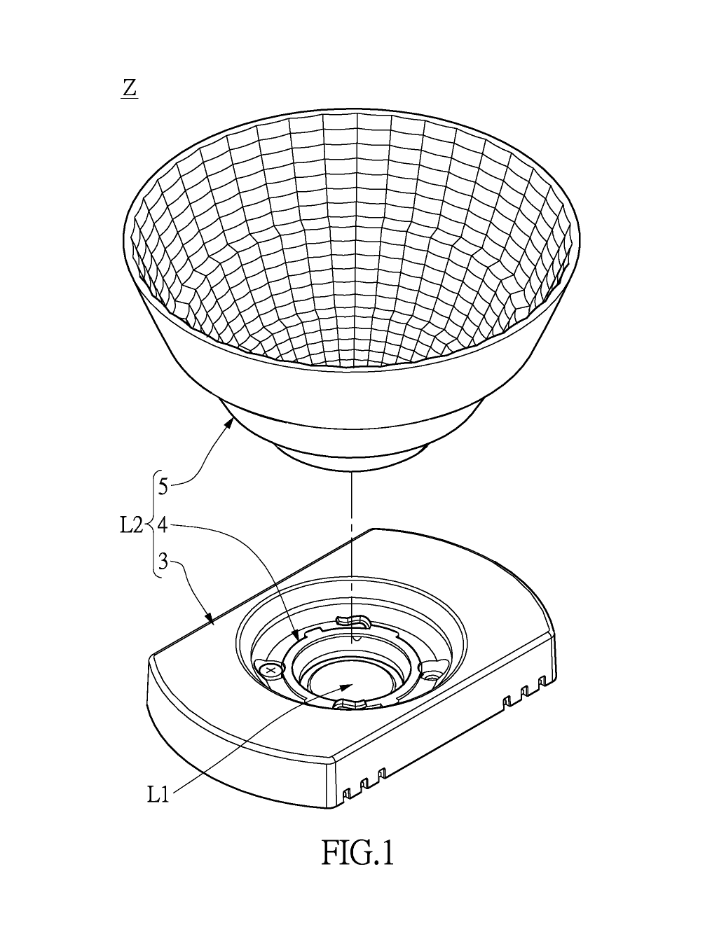

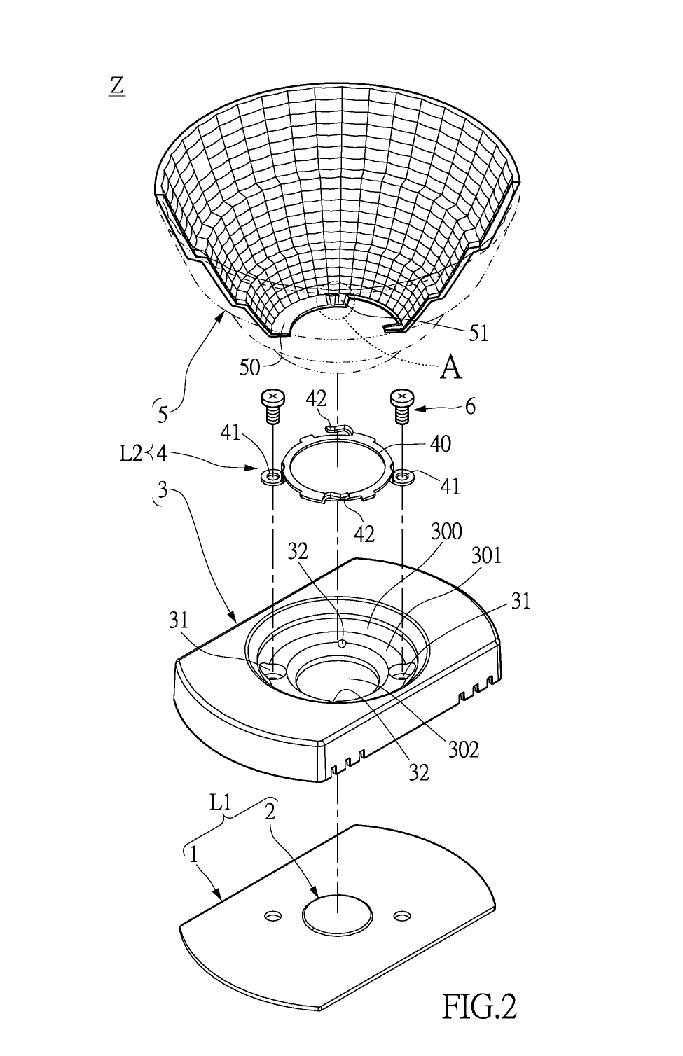

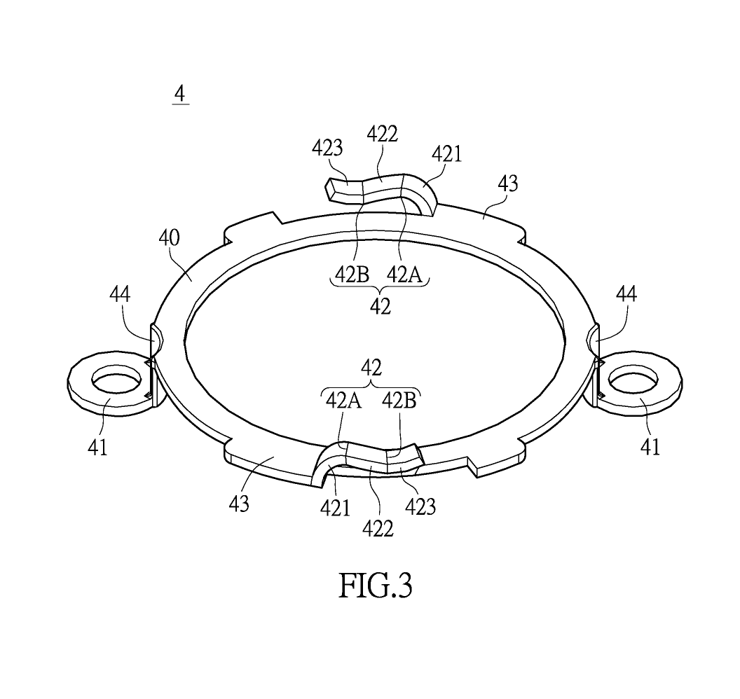

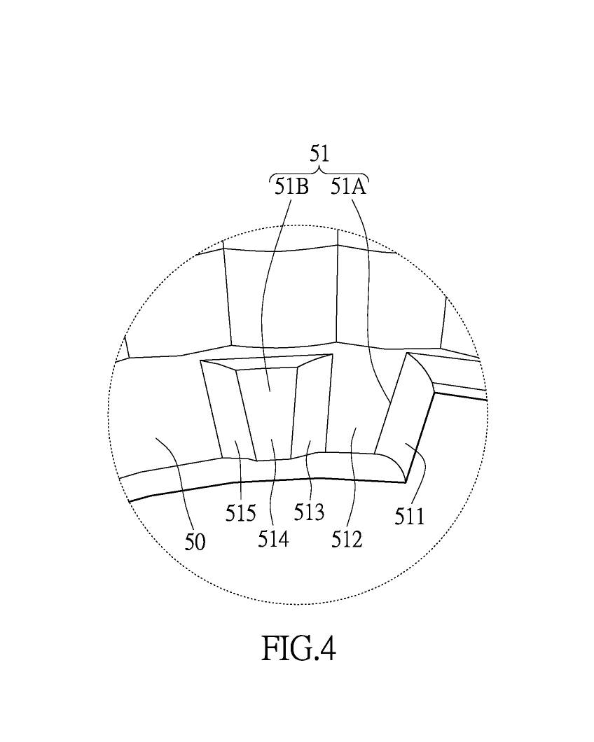

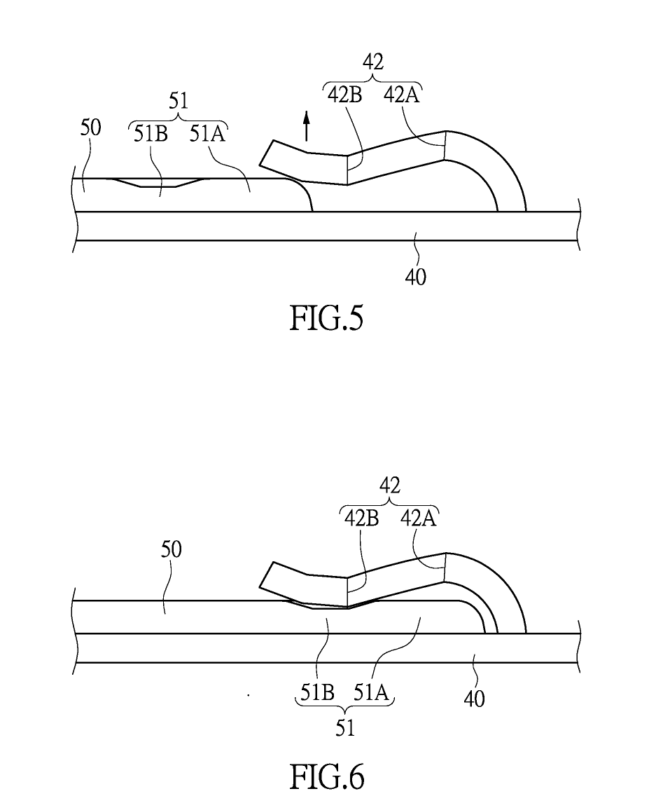

Referring to FIG. 1 to FIG. 6, in which FIG. 1 shows a partial assembled schematic view of the illumination device according to the instant disclosure, FIG. 2 shows an exploded schematic view of the illumination device according to the instant disclosure, FIG. 3 shows a perspective schematic view of the carrying structure according to the instant disclosure, FIG. 4 shows an enlarged view taken on part A of FIG. 2, FIG. 5 shows a cross-sectional schematic view showing the relationship between the first retaining portion and the second retaining portion before retaining the first retaining portion with the second retaining portion according to the instant disclosure, and FIG. 6 shows a cross-sectional schematic view showing the relationship between the first retaining portion and the second retaining portion after retaining the first retaining portion with the second retaining portion according to the instant disclosure.

Referring to FIG. 1 to FIG. 6, the instant disclosure provides an illumination device Z, comprising: a light-emitting module L1 and a lampshade module L2.

First, referring to FIG. 1 and FIG. 2, the light-emitting module L1 includes a circuit substrate 1 and a light-emitting unit 2 disposed on the circuit substrate 1 and electrically connected to the circuit substrate 1. For example, the light-emitting unit 2 includes a plurality of light-emitting diode (LED) chips disposed on the circuit substrate 1 and a package resin body disposed on the circuit substrate 1 for enclosing the LED chips. In addition, the lampshade module L2 includes a casing structure 3 disposed on the circuit substrate 1, a carrying (carrier) structure 4 detachably disposed on the casing structure 3, and a replaceable lampshade structure 5 detachably disposed on the carrying structure 4. For example, the casing structure 3 has a receiving space 300 downwardly concaved from a top side thereof, and the casing structure 3 has a surrounding carrying surface 301 disposed in the receiving space 300 and an opening 302 communicated with the receiving space 300 for exposing the light-emitting unit 2. In addition, the carrying structure 4 may be a metal stamping member, and the replaceable lampshade structure 5 may be any type of reflectors, but these are merely an example and are not meant to limit the instant disclosure.

Moreover, referring to FIG. 1, FIG. 2, and FIG. 3, the casing structure 3 has at least two first positioning portions 31 diagonally disposed on the surrounding carrying surface 301, and the carrying structure 4 has at least two second positioning portions 41 respectively corresponding to the at least two first positioning portions 31. Therefore, the carrying structure 4 can be detachably positioned on the surrounding carrying surface 301 of the casing structure 3 by matching the at least two first positioning portions 31 and the at least two second positioning portions 41. More precisely, after matching the at least two first positioning portions 31 and the at least two second positioning portions 41, the instant disclosure can use a plurality of securing members 6 (such as screw bolts) to concurrently pass through the second positioning portion 41 and the first positioning portion 31, so as to firmly position the carrying structure 4 on the surrounding carrying surface 301 of the casing structure 3. However, this is merely an example and is not meant to limit the instant disclosure.

Furthermore, referring to FIG. 1, FIG. 2, FIG. 5, and FIG. 6, the carrying structure 4 has at least two first retaining portions 42 diagonally disposed thereon, and the replaceable lampshade structure 5 has at least two second retaining portions 51 respectively corresponding to the first retaining portions 42. Therefore, the replaceable lampshade structure 5 can be detachably positioned on the carrying structure 4 by matching the at least two first retaining portions 42 and the at least two second retaining portions 51. More precisely, after placing the replaceable lampshade structure 5 on the carrying structure 4, the second retaining portion 51 can be moved from a first position (as shown in FIG. 5) beside the first retaining portion 42 to a second position (as shown in FIG. 6) under the first retaining portion 42 by rotating the replaceable lampshade structure 5.

For example, referring to FIG. 2, FIG. 3, and FIG. 4, the first positioning portion 31 may be a positioning hole, and the second positioning portion 41 may be a positioning member received in the first positioning portion 31. In addition, the first retaining portion 42 may be an elastic pressing piece, and the second retaining portion 51 may be a retaining block downwardly abutted and retained by the first retaining portion 42. Moreover, the casing structure 3 has at least two auxiliary positioning holes 32 disposed on the surrounding carrying surface 301, and the at least two auxiliary positioning holes 32 are covered by the carrying structure 4.

More precisely, referring to FIG. 3, the carrying structure 4 has an annular body 40, at least two first extending portions 43 extended outwardly from the annular body 40, and at least two second extending portions 44 extended downwardly from the annular body 40. In addition, the at least two first retaining portions 42 are respectively extended from two ends of the at least two first extending portions 43 and along a curved trace of the annular body 40, and the at least two second positioning portions 41 are respectively extended outwardly from two ends (such as bottommost side) of the at least two second extending portions 44. However, this is merely an example and is not meant to limit the instant disclosure.

More precisely, referring to FIG. 2 and FIG. 3, the replaceable lampshade structure 5 has at least two base portions 50 disposed on a bottom side thereof and inwardly extended, and slidably disposed on the annular body 40, and the at least two second retaining portions 51 are respectively connected to the at least two base portions 50. In addition, each first retaining portion 42 may be divided into a first front retaining section 42A and a first rear retaining section 42B extended from the first front retaining section 42A. For example, each first retaining portion 42 has a first curved section 421 gradually forwardly and upwardly extended therefrom, a second curved section 422 gradually forwardly and downwardly extended from the first curved section 421, and a third curved section 423 gradually forwardly and upwardly extended from the second curved section 422. However, this is merely an example and is not meant to limit the instant disclosure.

More precisely, referring to FIG. 2 and FIG. 4, each second retaining portion 51 may be divided into a second front retaining section 51A and a second rear retaining section 51B connected between the base portion 50 and the second front retaining section 51A. For example, each second retaining portion 51 has a curved side 511, a first top plane 512 connected to the curved side 511, a first inner curved surface 513 connected to the first top plane 512, a second top plane 514 connected to the first inner curved surface 513, and a second inner curved surface 515 connected to the second top plane 514 and corresponding to the first inner curved surface 513. However, this is merely an example and is not meant to limit the instant disclosure.

It is worth mentioning that, referring to FIG. 2 and FIG. 4, after placing the replaceable lampshade structure 5 on the carrying structure 4, the second retaining portion 51 can be moved from a first position (as shown in FIG. 5) beside the first retaining portion 42 to a second position (as shown in FIG. 6) under the first retaining portion 42 by rotating the replaceable lampshade structure 5. After matching the second retaining portion 51 and the first retaining portion 42, the second front retaining section 51A corresponds to the first front retaining section 42A, and the second rear retaining section 51B and the first rear retaining section 42B are mated with each other.

In conclusion, the light pattern of the illumination light source generated by the illumination device Z can be adjusted according to different requirements due to the designs of “the replaceable lampshade structure 5 detachably disposed on the carrying structure 4” and “the carrying structure 4 having at least two first retaining portions 42, the replaceable lampshade structure 5 having at least two second retaining portions 51 respectively corresponding to the first retaining portions 42, and the replaceable lampshade structure 5 detachably positioned on the carrying structure 4 by matching the at least two first retaining portions 42 and the at least two second retaining portions 51”.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. An illumination device, comprising:
a light-emitting module including a circuit substrate and a light-emitting unit disposed on the circuit substrate and electrically connected to the circuit substrate; and
a lampshade module including a casing structure disposed on the circuit substrate, a carrying structure detachably disposed on the casing structure, and a replaceable lampshade structure detachably disposed on the carrying structure;
wherein the casing structure has a receiving space downwardly concaved from a top side thereof, the casing structure has a surrounding carrying surface disposed in the receiving space and an opening communicated with the receiving space for exposing the light-emitting unit;
wherein the casing structure has at least two first positioning portions disposed on the surrounding carrying surface, the carrying structure has at least two second positioning portions respectively corresponding to the at least two first positioning portions, and the carrying structure is detachably positioned on the surrounding carrying surface of the casing structure by matching the at least two first positioning portions and the at least two second positioning portions;
wherein the carrying structure has at least two first retaining portions, the replaceable lampshade structure has at least two second retaining portions respectively corresponding to the first retaining portions, and the replaceable lampshade structure is detachably positioned on the carrying structure by matching the at least two first retaining portions and the at least two second retaining portions.

2. The illumination device of claim 1, wherein the first positioning portion is a positioning hole, and the second positioning portion is a positioning member received in the first positioning portion, wherein the first retaining portion is an elastic pressing piece, and the second retaining portion is a retaining block downwardly abutted and retained by the first retaining portion, wherein the casing structure has at least two auxiliary positioning holes disposed on the surrounding carrying surface, and the at least two auxiliary positioning holes are covered by the carrying structure.

3. The illumination device of claim 1, wherein the carrying structure has an annular body, at least two first extending portions extended outwardly from the annular body, and at least two second extending portions extended downwardly from the annular body, the at least two first retaining portions are respectively extended from two ends of the at least two first extending portions, and the at least two second positioning portions are respectively extended outwardly from two ends of the at least two second extending portions.

4. The illumination device of claim 3, wherein the replaceable lampshade structure has at least two base portions disposed on a bottom side thereof and inwardly extended, and slidably disposed on the annular body, the at least two second retaining portions are respectively connected to the at least two base portions, each first retaining portion is divided into a first front retaining section and a first rear retaining section extended from the first front retaining section, and each second retaining portion is divided into a second front retaining section corresponding to the first front retaining section and a second rear retaining section connected between the base portion and the second front retaining section and mated with the first rear retaining section.

5. The illumination device of claim 1, wherein each first retaining portion has a first curved section gradually forwardly and upwardly extended therefrom, a second curved section gradually forwardly and downwardly extended from the first curved section, and a third curved section gradually forwardly and upwardly extended from the second curved section, and each second retaining portion has a curved side, a first top plane connected to the curved side, a first inner curved surface connected to the first top plane, a second top plane connected to the first inner curved surface, and a second inner curved surface connected to the second top plane and corresponding to the first inner curved surface.

6. A lampshade module, comprising:
a casing structure;
a carrying structure detachably disposed on the casing structure; and
a replaceable lampshade structure detachably disposed on the carrying structure;
wherein the casing structure has a receiving space downwardly concaved from a top side thereof, the casing structure has a surrounding carrying surface disposed in the receiving space and an opening communicated with the receiving space for exposing a light-emitting unit;
wherein the casing structure has at least two first positioning portions disposed on the surrounding carrying surface, the carrying structure has at least two second positioning portions respectively corresponding to the at least two first positioning portions, and the carrying structure is detachably positioned on the surrounding carrying surface of the casing structure by matching the at least two first positioning portions and the at least two second positioning portions;
wherein the carrying structure has at least two first retaining portions, the replaceable lampshade structure has at least two second retaining portions respectively corresponding to the first retaining portions, and the replaceable lampshade structure is detachably positioned on the carrying structure by matching the at least two first retaining portions and the at least two second retaining portions.

7. The lampshade module of claim 6, wherein the first positioning portion is a positioning hole, and the second positioning portion is a positioning member received in the first positioning portion, wherein the first retaining portion is an elastic pressing piece, and the second retaining portion is a retaining block downwardly abutted and retained by the first retaining portion, wherein the casing structure has at least two auxiliary positioning holes disposed on the surrounding carrying surface, and the at least two auxiliary positioning holes are covered by the carrying structure.

8. The lampshade module of claim 6, wherein the carrying structure has an annular body, at least two first extending portions extended outwardly from the annular body, and at least two second extending portions extended downwardly from the annular body, the at least two first retaining portions are respectively extended from two ends of the at least two first extending portions, and the at least two second positioning portions are respectively extended outwardly from two ends of the at least two second extending portions.

9. The lampshade module of claim 8, wherein the replaceable lampshade structure has at least two base portions disposed on a bottom side thereof and inwardly extended, and slidably disposed on the annular body, the at least two second retaining portions are respectively connected to the at least two base portions, each first retaining portion is divided into a first front retaining section and a first rear retaining section extended from the first front retaining section, and each second retaining portion is divided into a second front retaining section corresponding to the first front retaining section and a second rear retaining section connected between the base portion and the second front retaining section and mated with the first rear retaining section.

10. The lampshade module of claim 6, wherein each first retaining portion has a first curved section gradually forwardly and upwardly extended therefrom, a second curved section gradually forwardly and downwardly extended from the first curved section, and a third curved section gradually forwardly and upwardly extended from the second curved section, and each second retaining portion has a curved side, a first top plane connected to the curved side, a first inner curved surface connected to the first top plane, a second top plane connected to the first inner curved surface, and a second inner curved surface connected to the second top plane and corresponding to the first inner curved surface.
